(19) United States
(12) Patent Application Publication
(10) Pub. No.: US 2012/0021244 A1
(43) Pub. Date: Jan. 26, 2012

(54) PROCESS FOR JOINING STAINLESS STEEL PART AND ALUMINA CERAMIC PART AND COMPOSITE ARTICLES MADE BY SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); WEN-FENG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/097,214

(22) Filed: Apr. 29, 2011

(30) Foreign Application Priority Data
Jul. 22, 2010 (CN) 201010233919.7

(51) Int. Cl. B21D 39/00; B23K 31/00

(52) U.S. Cl. 428/621; 219/148

(57) ABSTRACT

A process for joining a stainless steel part and a alumina ceramic part, comprising steps of: providing a metal part made of stainless steel, a ceramic part made of alumina ceramic, and a nickel foil; bring the metal part, ceramic part, and nickel foil into contact, with the nickel foil inserted between the metal part and ceramic part; applying a joining pressure of about 20˜60 MPa to the parts to be joined; and simultaneously applying a pulse electric current to the parts while the joining pressure is applied for heating up the parts to a joining temperature of about 950° C. to about 1150° C. at a rate of about 50˜300° C./min, maintaining the joining temperature for about 20˜40 minutes.

### CROSS-REFERENCE TO RELATED APPLICATIONS

The present application is related to co-pending U.S. patent application Ser. No. (Attorney Docket No. US34441), entitled “PROCESS FOR JOINING CARBON STEEL PART AND ZIRCONIA CERAMIC PART AND COMPOSITE ARTICLES MADE BY SAME”, by Zhang et al. These applications have the same assignee as the present application and have been concurrently filed herewith. The above-identified applications are incorporated herein by reference.

### BACKGROUND

1. Technical Field

The exemplary disclosure generally relates to a process for joining a metal part and a ceramic part, especially to a process for joining a stainless steel part and an alumina ceramic part, and an article made by the process.

2. Description of Related Art

It is desirable to join stainless steel parts and alumina ceramic parts. However, due to distinct physical and chemical properties, it is difficult to join stainless steel and alumina ceramic using traditional bonding methods such as braze welding, fusion welding, solid diffusion bonding.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary process for joining stainless steel part and alumina ceramic part, and composite article made by the process. Moreover, in the drawings like reference numerals designate corresponding parts throughout the several views. Wherever possible, the same reference numbers are used throughout the drawings to refer to the same or like elements of an embodiment.

FIG. 1 is a schematic cross-sectional view of an example of a spark plasma sintering device for implementing the present process.

FIG. 2 is a cross-sectional view of an exemplary embodiment of the present article made by the present process.

### DETAILED DESCRIPTION

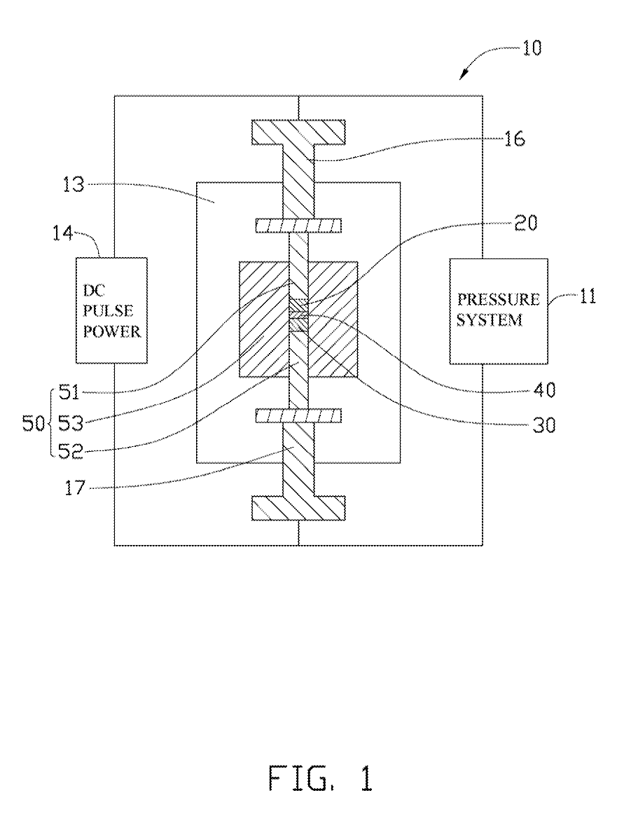

The process according to the present disclosure is generally implemented by a spark plasma sintering (SPS) device as illustrated in FIG. 1.

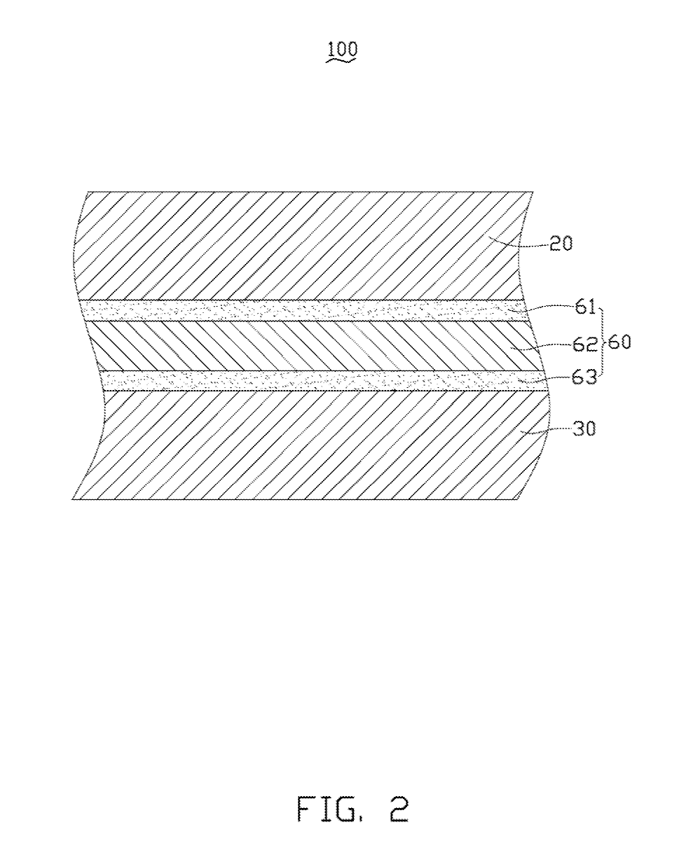

Referring to FIGS. 1 and 2, an exemplary process for joining a stainless steel part and an alumina ceramic part may include the following steps.

A metal part 20 made of stainless steel, a ceramic part 30 made of alumina ceramic, and an intermediate member 40 are provided. The intermediate member 40 is used as a joining medium between the surfaces of the metal part 20 and the ceramic part 30. The intermediate member 40 may be a nickel foil having a thickness of about 0.1˜0.5 mm. In this exemplary embodiment, the thickness of the active intermediate member 40 is about 0.2˜0.3 mm.

The metal part 20, ceramic part 30, and intermediate member 40 are pretreated. The pretreatment may include polishing the surfaces of the metal part 20, ceramic part 30, and intermediate member 40, by such as 400˜800 grit abrasive paper. Then, the metal part 20, ceramic part 30, and intermediate member 40 may be activated through a cleaning with solution containing hydrochloric acid or sulphuric acid. Then, the metal part 20, ceramic part 30, and intermediate member 40 are rinsed with water and dried.

A mold 50 made of electro-conductive material, such as graphite, is provided as shown in FIG. 1. The mold 50 includes an upper pressing head 51, a lower pressing head 52, and a middle part 53. The middle part 53 defines a cavity (no shown) for accommodating the parts to be joined.

The metal part 20, ceramic part 30, and intermediate member 40 are placed into the mold 50 with the intermediate member 40 inserted between the metal part 20 and the ceramic part 30. The upper pressing head 51 and the lower pressing head 52 from two opposite sides, bring the surfaces of the parts to be joined into tight contact, for compressing the metal part 20, ceramic part 30, and intermediate member 40 therebetween.

A SPS device 10 is provided. The SPS device 10 includes a pressure system 11 for providing pressure to the parts to be joined, a sintering chamber 13, and a DC pulse power 14 for providing pulse current to the parts and heating up the parts. In this exemplary embodiment, the SPS device 10 is a “SPS3.20MK-IV” type device sold by SUMITOMO Ltd.

The mold 50 is placed in the sintering chamber 13. The upper pressing head 51 and the lower pressing head 52 are electrically connected to the positive electrode 16 and negative electrode 17 of the DC pulse power 14. The sintering chamber 13 is evacuated to a vacuum level of about 6 Pa to about 10 Pa. A pressure, known as the joining pressure of about 20˜60 MPa is then applied to the parts through the upper pressing head 51 and the lower pressing head 52. While the joining pressure is applied, a pulse electric current of about 3000˜4000A is simultaneously applied to the parts, heating the parts at a rate of about 50˜300 degrees Celsius per minute (° C./min). When the temperature of the parts arrives at a joining temperature (about 950° C. to about 1150° C.), the parts is maintained at the joining temperature for about 20˜40 minutes. Under the joining pressure and the joining temperature, particles of the metal part 20, ceramic part 30, and intermediate member 40 react and diffuse with each other to form a joining part 60 (shown in FIG. 2) between the metal part 20 and the ceramic part 30. Thereby, the metal part 20 and the ceramic part 30 are joined via the intermediate member 40, forming a composite article 100. In this exemplary embodiment, the parts are heated at a rate of about 60˜200° C./min. The joining temperature is about 1000° C. to about 1100° C. The joining temperature is maintained for about 25˜35 minutes.

Once cooled down, the composite article 100 can be removed.

Owing to the present process, a final, permanent joint, of great strength is obtained. The process requires a short hold time and a low vacuum level of the sintering chamber 13, thus producing significant time and energy savings.

FIG. 2 shows a composite article 100 manufactured by the present process. The composite article 100 includes the metal part 20, the ceramic part 30, and the now-formed joining part 60. The joining part 60 includes a first transition layer 61, a nickel layer 62, and a second transition layer 63. The first transition layer 61 is located between the metal part 20 and the nickel layer 62. The first transition layer 61 may be substantially comprised of solid solutions of nickel and iron, intermetallic compounds of nickel and iron, and a few of intermetallic compounds of nickel and chromium. The second transition layer 63 is located between the ceramic part 30 and the nickel layer 62. The second transition layer 63 may be substantially comprised of compounds of nickel and oxygen, compounds of nickel and aluminum, and a few of solid solution of nickel and aluminum.

The first transition layer 61 and the second transition layer 63 each may have a thickness of about 5˜30 μm, and preferably about 10˜20 μm.

The joining part 60 of the composite article 100 has no crack and aperture, and has a smooth surface. The metal/ceramic interface of the composite article 100 has a shear strength of about 80˜150 MPa.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process for joining a stainless steel part and an alumina ceramic part, comprising steps of:
providing a metal part made of stainless steel, a ceramic part comprised of alumina ceramic, and a nickel foil;
bringing surfaces of the metal part, ceramic part, and nickel foil into contact, with the nickel foil inserted between the metal part and the ceramic part;
applying a joining pressure of about 20˜60 MPa to the metal part, ceramic part, and nickel foil; and simultaneously applying a pulse electric current to the metal part, ceramic part, and nickel foil while the joining pressure is applied, heating up the metal part, ceramic part, and nickel foil to a joining temperature of about 950° C. to about 1150° C. at a rate of about 50˜300° C./min, and maintaining the joining temperature for about 20˜40 minutes.

2. The process as claimed in claim 1, wherein the step of bring surfaces into contact further comprises placing the metal part, ceramic part, and nickel foil in a mold; the mold including an upper pressing head and a lower pressing head; the upper pressing head and the lower pressing head from two opposite sides fixing the metal part, ceramic part, and nickel foil therebetween.

3. The process as claimed in claim 2, wherein the mold is made of graphite.

4. The process as claimed in claim 2, wherein the step of applying the joining pressure further comprises placing the mold in a sintering chamber of a spark plasma sintering device spark plasma sintering, the joining pressure being applied to the metal part, ceramic part, and nickel foil through the upper pressing head and the lower pressing head.

5. The process as claimed in claim 4, wherein the sintering chamber being evacuated to a vacuum level of about 6 Pa to about 10 Pa.

6. The process as claimed in claim 4, wherein the spark plasma sintering device has a DC pulse power, the upper pressing head and the lower pressing head are respectively electrically connected with the positive electrode and the negative electrode of the DC pulse power.

7. The process as claimed in claim 1, wherein the metal part, ceramic part, and nickel foil are heated at a rate of about 60˜200° C./min.

8. The process as claimed in claim 1, wherein the joining temperature is about 1000° C. to about 1100° C., the joining temperature maintained for about 25˜35 minutes.

9. The process as claimed in claim 1, wherein the pulse electric current applied to the metal part, ceramic part, and nickel foil is about 2500˜4500A.

10. The process as claimed in claim 1, wherein the nickel foil has a thickness of about 0.1˜0.5 mm.

11. The process as claimed in claim 1, wherein the process further comprising polishing the metal part, ceramic part, and nickel foil and activating the metal part, ceramic part, and nickel foil by cleaning with solution containing hydrochloric acid or sulphuric acid, before the step of bring into contact.

12. A composite article, comprising:
a metal part made of stainless steel;
a ceramic part made of alumina ceramic; and
a joining part, the joining part including a first transition layer, a nickel layer, and a second transition layer, the first transition layer being located between the metal part and the nickel layer, the first transition layer being comprised of solid solutions of nickel and iron, intermetallic compounds of nickel and iron, and intermetallic compounds of nickel and chromium, the second transition layer being located between the ceramic part and the nickel layer, the second transition layer being comprised of compounds of nickel and oxygen, compounds of nickel and aluminum, and solid solution of nickel and aluminum.

13. The composite article as claimed in claim 12, wherein the first transition layer and the second transition layer each has a thickness of about 5˜30 μm.

14. The composite article as claimed in claim 13, wherein the first transition layer and the second transition layer each has a thickness of about 10˜20 μm.

15. The composite article as claimed in claim 12, wherein the composite article has a shear strength of about 80˜150 MPa.
